(19) United States
(12) Patent Application Publication
(10) Pub. No.: US 2003/0027113 A1
(43) Pub. Date: Feb. 6, 2003

(54) System and method of teaching reading and writing

(75) Inventor: Kazuko Curtin, Austin, TX (US)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(73) Assignee: Kazuko Curtin, Austin, TX

(21) Appl. No.: 10/098,011

(22) Filed: Mar. 14, 2002

Related U.S. Application Data
(60) Provisional application No. 60/276,274, filed on Mar. 15, 2001.

(51) Int. Cl. G09B 1/16

(52) U.S. Cl. 434/172

(57) ABSTRACT

A visual learning system includes a presentation surface having hook and loop fasteners disposed thereon, at least one target picture card having a graphical representation of a target subject matter depicted thereon, where the at least one target picture card being detachably affixable to the presentation surface. A plurality of text cards are detachably affixable to the presentation surface, where the plurality of text cards being operable to form a prompt sentence and an expression sentence describing at least one aspect of the target subject matter.

### RELATED APPLICATIONS

The present patent application claims the benefit of provisional patent application No. 60/2276,274, entitled System and Method of Teaching Reading and Writing, filed on Mar. 15, 2001, and is further related to pending patent application Ser. No. 09/791,084, titled Visual Learning Aid System and Method, filed on Feb. 22, 2001.

### TECHNICAL FIELD OF THE INVENTION

This invention relates to teaching aides and more particularly to a system and method of teaching reading and writing.

### BACKGROUND OF THE INVENTION

For the parents and teachers of many autistic children, conventional teaching methods such as Applied Behavior Analysis (ABA) are disappointing because they fail to elicit progress commonly seen other children affected to a lesser degree. These non-reachable children remain cloistered in their own worlds with distant stares and self-stimulate with repetitive stemming movements and sounds. They do not communicate with the outside world; most do not speak. Experts label these children as “low functioning” with a despairing prognosis. These experts often advise the parents of low functioning children to institutionalize them and forget about them. These experts have nothing to offer. As far as they know, there is no cure for autism and there is no known teaching method that can bridge the chasm to reach these non-communicative children. As a result, many parents give up, leaving behind a legacy of unfulfilled expectations and broken hearts.

Children affected to a somewhat lesser degree but with verbalizing difficulties have been provided tools such as the Picture Exchange Communication System (PECS) books and activity boards (Pyramid Educational Consultants, Inc. Newark, Del.) as a means of expressing their needs. These tools uses small cards bearing pictures and accompanying text, where the picture is the dominant feature. These small picture cards may be used by children to form primitive sentences, such as “I” “WANT” “WATER” OR “I” “WANT” “JUICE” in order to communicate their needs or desires. The books are equipped with a few strips of hook and loop fasteners which enable the child to adhere the small picture cards to the book binder cover or pages inside the cover.

Although the PECS system allows children to communicate very simple thoughts and needs, the PECS system does not lend itself to advancement beyond this stage. The PECS books becomes a crutch for the children and parents who have come to rely on them as a form of communications, but no more than that. It also appears that the children's reliance on the pictures does not translate very well to a world that does not operate using PECS.

### SUMMARY OF THE INVENTION

In accordance with an embodiment of the present invention, a visual learning system includes a presentation surface having hook and loop fasteners disposed thereon, at least one target picture card having a graphical representation of a target subject matter depicted thereon, where the at least one target picture card being detachably affixable to the presentation surface. A plurality of text cards are detachably affixable to the presentation surface, where the plurality of text cards being operable to form a prompt sentence and an expression sentence describing at least one aspect of the target subject matter.

In accordance with another embodiment of the present invention, a visual teaching tool includes a binder having a presentation surface with hook and loop fasteners disposed thereon, where the binder further has a plurality of storage pages, a plurality of target picture cards each having a graphical representation of a target subject matter depicted thereon, where the plurality of target picture cards are detachably affixable to the presentation surface, and a plurality of text cards detachably affixable to the presentation surface, where the plurality of text cards are operable to form a prompt sentence and an expression sentence describing at least one aspect of the target subject matter. The plurality of target picture cards and plurality of text cards are detachably affixable to hook and loop fasteners disposed on the plurality of storage pages in the binder.

In accordance with another embodiment of the invention, a teaching method includes the steps of presenting to a student at least one target picture card having a graphical representation of a target subject matter depicted thereon, presenting to the student a first set of text cards forming a prompt sentence naming the target subject matter, and then accepting from the student a second set of text cards forming an expression sentence naming the target subject matter.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is an isometric view of an embodiment of the present invention according to the teachings of the present invention;

FIG. 2 is another isometric view of an embodiment of the present invention according to the teachings of the present invention;

FIG. 3 is a top view of a plurality of text and picture cards employed in an embodiment of the present invention according to the teachings of the present invention;

FIG. 4 is a top view of an embodiment of divider pages that may be employed in the present invention; and

FIG. 5 is a flowchart of a preferred embodiment of a teaching method of the present invention.

### DETAILED DESCRIPTION OF THE DRAWINGS

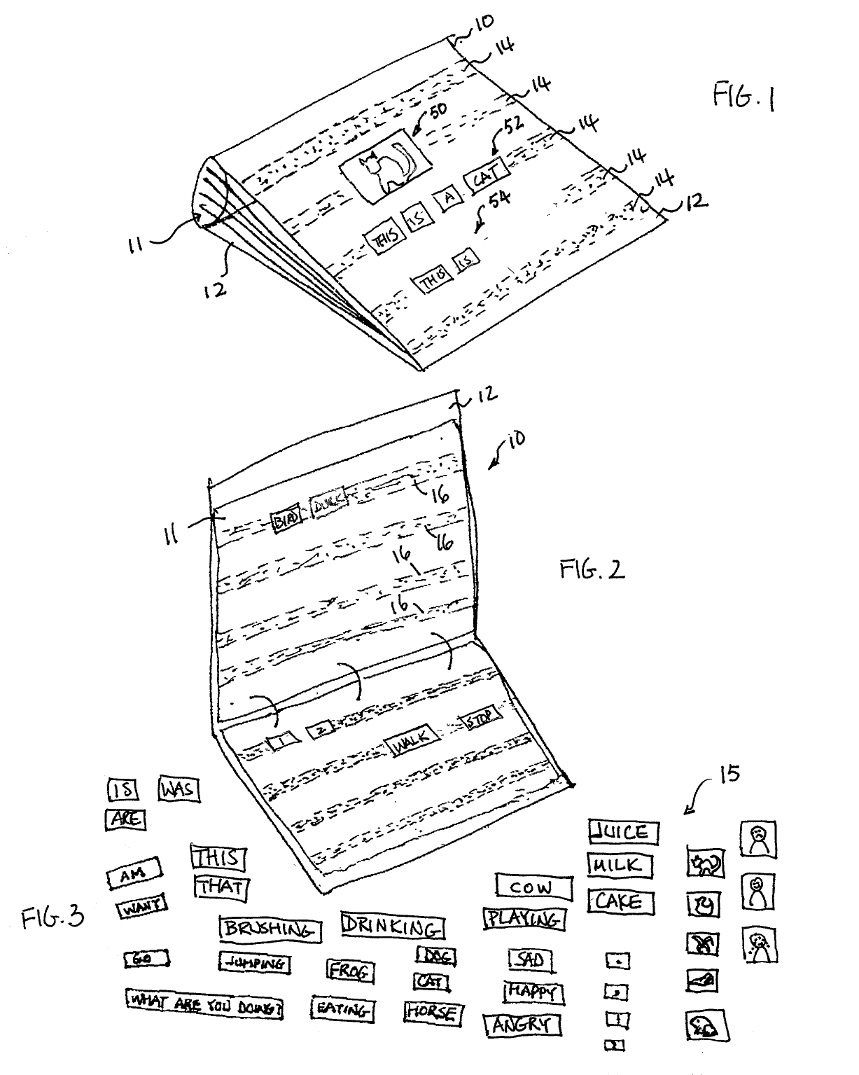

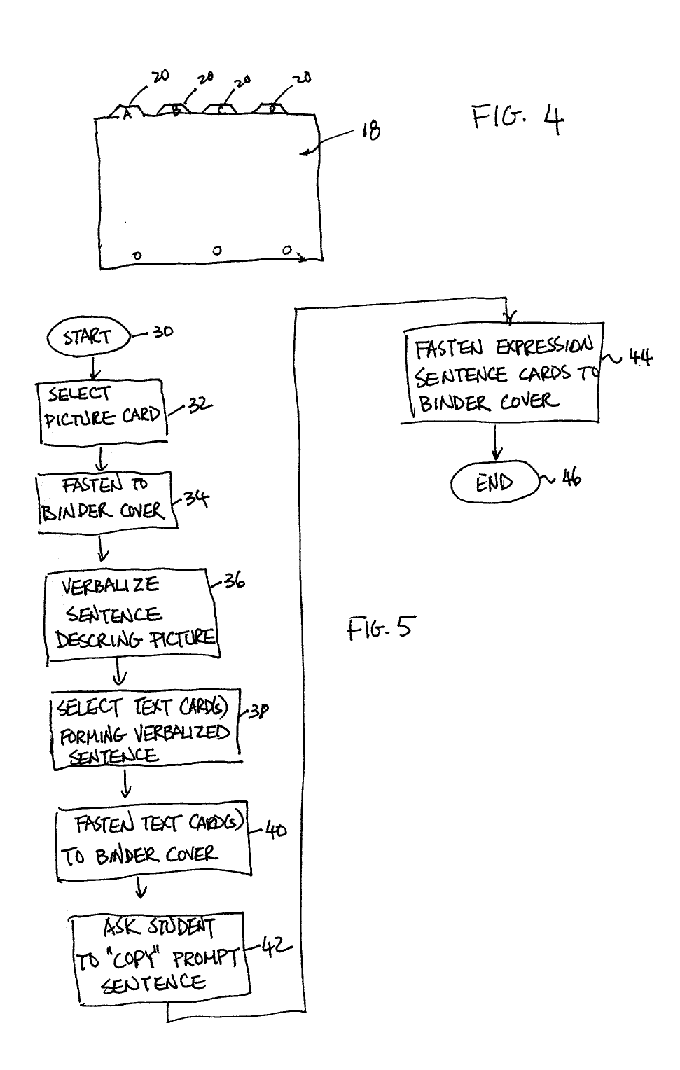

The preferred embodiment of the present invention and its advantages are best understood by referring to FIGS. 1 through 5 of the drawings, like numerals being used for like and corresponding parts of the various drawings.

In an embodiment of the present invention, the system described in Visual Learning Aid System and Method (Ser. No. 09/791,084) is made more portable by the present invention by providing a binder 10 and a means of organizing the picture cards and text cards, and a new way of presenting the picture cards and text cards, as shown in FIG. 1. Binder 10 may be a loose leaf notebook and the like that allows the user to add or remove storage pages 11. Binder 10 preferably has stiff outer covers 12. On at least one exterior surface of outer cover 12 there are one or more parallel strips of hook and loop-type fastener 14 placed thereon. Although shown as arranged in a parallel configuration, hook and loop fastener 14 may be arranged in other configurations, such as a grid, star, wheel-and-spoke, etc. Alternatively, the entire exterior binder cover surface may be covered in hook and loop fasteners.

As seen in FIG. 2, storage pages 11 also each includes strips of hook and loop fasteners 16 arranged in an orderly fashion thereon. A plurality of picture and text cards 15 (FIG. 3) may be arranged on storage pages 11. Picture cards and text cards 15 can be organized by subject, parts-of-speech (POS), etc. in different sections or on different storage pages in binder 10. For example, the binder may include text cards naming verbs or action, “WANT”, “AM”, “SEE”, “JUMPING”, “EATING”, “BRUSHING”, “WALKING”, etc; text cards naming foods, “HOT DOG”, “FRENCH FRIES”, “MILK”, “JUICE”, etc.; text cards naming animals, “FROG”, “DOG”, “CAT”, “COW”, “MOCKING BIRD”, “HORSE”, etc.; text cards naming professions, “FIREMAN”, “DOCTOR”, “TEACHER”, “MOTHER”, “MAILMAN”, “CHEF”, etc.; text cards naming feelings or emotions, which has “SAD”, “HAPPY”, “ANGRY”, “COLD”, “HOT”, etc. Furthermore, standard prompt sentences are included, such as “WHAT ARE YOU DOING?”, “WHAT DO YOU SEE?”, “HOW DO YOU FEEL?”, etc. The various sections of the binder may be separated by divider pages 18 as known in the art. Divider pages 18 may have a distinctive color that is different from storage pages 11 to facilitate easy location by the user. Further, divider pages 18 may have labeled tabs 20 that allows the user to easily and quickly locate the text or picture card he/she is looking for. The selection of the word cards and picture cards is dependent on the comprehensive level of the intended student recipient of this teaching tool and method and can be augmented as the student masters certain words or attains a greater level of comprehension.

In a preferred teaching method 30 of the present invention, as shown in FIG. 5, the instructor may select and fasten a target picture card 50 to binder cover 12 and presents it to the student, as shown in blocks 32 and 34. Target picture card 50 may have an illustration or photograph of a target subject matter. The target subject matter may be performing an activity or show an emotion. Please also refer to FIG. 1 for an illustration of the teaching method. The instructor may then verbalize a sentence that describes the target picture card, such as “This is a frog.” or “I am jumping on a trampoline”, as shown in block 36. The instructor then selects the text cards that form the verbalized sentence and secure them in the correct sequence on the hook and loop strip(s) proximately to the target picture card on binder cover 12, as shown in blocks 38 and 40. This forms the prompt sentence 52. The student is then asked to “copy” the sentence by selecting from the contents of the binder the correct text cards and to place them on a hook and loop strip adjacent to the prompt sentence, as shown in block 42. This forms the expression sentence 54. This process is repeated with one or more prompt sentences. As the student becomes familiar with the prompt sentence(s) or the type of sentence, the instructor may perform the exercise without using target picture card 50 by forming the prompt sentence on the binder cover and asking the student to copy it to form the expression sentence. The process ends in block 46.

The instructor may also form a second type of prompt sentence, such as using one of the standard prompts, after showing the student a target picture card. The instructor may aid the student by first forming a reply sentence below the prompt sentence. The student is then asked to copy the reply sentence by selecting and using the text cards. As the student becomes familiar with the sentence or the type of sentence, the instructor may perform the exercise without using the target picture card.

When the student has learned the basic instruction method, the system of the present invention can be used to teach reading and writing, unlike the PECS system, which is used as a communications tool. Furthermore, the eventual disassociation of a picture from the prompt sentence relieves the student from the reliance of using the picture as a cue. The student thus learns to recognize the words themselves rather than the combination of the picture and the word. The student also learns sentence patterns and structure, basic grammar, and other language skills. Therefore, the learned skills can be more easily translated and applied to the real world, which does not operate around the PECS system.

It may be seen that the present invention may take on other equally suitable forms. For example, a presentation board with strips of hook and loop fasteners arranged thereon may be used to present the picture card, and form the prompt, expression and reply sentences. Fun and stimulating colors may be used on the binder covers and the cards. The cards may also sport different colors for different parts-of-speech, subject or topic.

While the invention has been particularly shown and described by the foregoing detailed description, it will be understood by those skilled in the art that various changes, alterations, modifications, mutations and derivations in form and detail may be made without departing from the spirit and scope of the invention.

What is claimed is:

1. A visual learning system, comprising:
a presentation surface having hook and loop fasteners disposed thereon;
at least one target picture card having a graphical representation of a target subject matter depicted thereon, the at least one target picture card being detachably affixable to the presentation surface; and
a plurality of text cards detachably affixable to the presentation surface, the plurality of text cards being operable to form a prompt sentence and an expression sentence describing at least one aspect of the target subject matter.

2. The system, as set forth in claim 1, further comprising a binder having a plurality of storage pages, each storage page having hook and loop fasteners disposed thereon for detachably fastening the plurality of text cards and the at least one target picture card.

3. The system, as set forth in claim 1, wherein the presentation surface is an outer cover surface of a binder having a plurality of storage pages, each storage page having hook and loop fasteners disposed thereon for detachably fastening the plurality of text cards and the at least one target picture card.

4. The system, as set forth in claim 1, wherein the target subject matter is a person performing an activity, and the plurality of text cards include cards that form a sentence naming the activity.

5. The system, as set forth in claim 1, wherein the target subject matter is an animal, and the plurality of text cards include cards that form a sentence naming the animal.

6. The system, as set forth in claim 1, wherein the target subject matter is an emotion, and the plurality of text cards include cards that form a sentence naming the emotion.

7. The system, as set forth in claim 1, wherein the target subject matter is a profession, and the plurality of text cards include cards that form a sentence naming the profession.

8. The system, as set forth in claim 1, wherein the plurality of text cards comprises text cards of parts of speech.

9. The system, as set forth in claim 1, wherein the plurality of text cards comprises text cards of punctuation.

10. The system, as set forth in claim 1, wherein the presentation surface comprises a plurality of parallel strips of hook and loop fasteners arranged thereon.

11. A visual teaching tool, comprising:
a binder having a presentation surface with hook and loop fasteners disposed thereon, the binder further having a plurality of storage pages;
a plurality of target picture cards each having a graphical representation of a target subject matter depicted thereon, the plurality of target picture cards being detachably affixable to the presentation surface;
a plurality of text cards detachably affixable to the presentation surface, the plurality of text cards being operable to form a prompt sentence and an expression sentence describing at least one aspect of the target subject matter; and
the plurality of target picture cards and plurality of text cards being detachably affixable to hook and loop fasteners disposed on the plurality of storage pages in the binder.

12. The tool, as set forth in claim 11, wherein the presentation surface is an outer cover surface of the binder.

13. The tool, as set forth in claim 11, wherein the target subject matter is a person performing an activity, and the plurality of text cards include cards that form a sentence naming the activity.

14. The tool, as set forth in claim 11, wherein the target subject matter is an animal, and the plurality of text cards include cards that form a sentence naming the animal.

15. The tool, as set forth in claim 11, wherein the target subject matter is an emotion, and the plurality of text cards include cards that form a sentence naming the emotion.

16. The tool, as set forth in claim 11, wherein the target subject matter is a profession, and the plurality of text cards include cards that form a sentence naming the profession.

17. The tool, as set forth in claim 11, wherein the plurality of text cards comprises text cards of parts of speech.

18. The tool, as set forth in claim 11, wherein the plurality of text cards comprises text cards of punctuation.

19. The tool, as set forth in claim 11, wherein the presentation surface comprises a plurality of parallel strips of hook and loop fasteners arranged thereon.

20. A teaching method, comprising:
presenting to a student at least one target picture card having a graphical representation of a target subject matter depicted thereon;
presenting to the student a first set of text cards forming a prompt sentence naming the target subject matter; and
accepting from the student a second set of text cards forming an expression sentence naming the target subject matter.

21. The method, as set forth in claim 20, wherein presenting to the student comprises detachably affixing the at least one target picture card to a presentation surface.

22. The method, as set forth in claim 20, wherein presenting to the student the first set of text cards comprises detachably affixing the first set of text cards to the presentation surface.

23. The method, as set forth in claim 20, wherein accepting from the student the second set of text cards comprises detachably affixing the second set of text cards to the presentation surface.

24. The method, as set forth in claim 20, further comprising verbalizing the prompt sentence.

25. The method, as set forth in claim 20, wherein presenting the first set of text cards comprises presenting the first set of text cards forming a prompt sentence asking a question, and accepting the second set of text cards comprises accepting the second set of text cards forming a reply sentence responding to the question.
